(19) United States
(12) Patent Application Publication
(10) Pub. No.: US 2007/0170362 A1
(43) Pub. Date: Jul. 26, 2007

(54) Method and apparatus for internal reflection imaging

(75) Inventors: Brian M. Patterson, Los Alamos, NM (US); George J. Havrilla, Los Alamos, NM (US)

Correspondence Address: LOS ALAMOS NATIONAL SECURITY, LLC, LOS ALAMOS NATIONAL LABORATORY, PPO. BOX 1663, LC/IP, MS A187, LOS ALAMOS, NM, 87545, US

(73) Assignee: The Regents of the University of California

(21) Appl. No.: 11/339,045

(22) Filed: Jan. 25, 2006

(51) Int. Cl. G01J 5/02

(52) U.S. Cl. 250/339.07

(57) ABSTRACT

An internal reflectance element assembly, that is defined by a crystal that has at least one measured dimension of about 5 mm or greater that is held in a holder structure shaped to hold the crystal, and a backer plate to secure a sample to the crystal.

### STATEMENT REGARDING FEDERAL RIGHTS

This invention was made with government support under Contract No. W-7405-ENG-36 awarded by the U.S. Department of Energy. The government has certain rights in the invention.

### FIELD OF THE INVENTION

The present invention relates generally off axis spectroscopic imaging, and, more particularly, to attenuated total internal reflection microspectroscopic imaging.

### BACKGROUND OF THE INVENTION

Attenuated total internal reflectance (ATR) microscopy couples an energy source, historically infrared energy, with an internal reflectance element (IRE). The IRE is a high index of refraction material, typically a crystal, such that when the light entering the IRE is at an angle greater than the critical angle, total internal reflection occurs. A very small evanescent wave of light penetrates out of the crystal at the point of reflection. The penetration depth of the evanescent wave out of the IRE and into the sample is governed by the refractive index of both the sample, the IRE, the angle of the light, and the wavelength of light divided by the IRE refractive index used.

Historically, there have been only two methods of ATR infrared imaging; in each case the IRE is no larger than 3 mm (millimeters). The first method, a focal plane array camera consisting of hundreds to thousands of pixels is used to image samples very quickly; this ATR method is exemplified in U.S. Pat. No. 6,141,100, issued on Oct. 31, 2000 to Burka et al. However, this method is limited by the field of view of the camera. If the sample area of interest is larger than the camera's field of view, then another method must be found. The IRE and the camera are along the same optical axis, and the IRE and the sample do not move during the data collection cycle.

The second ATR method uses a stationary drop down IRE. This type of apparatus is exemplified in U.S. Pat. No. 5,729,018, issued on Mar. 17, 1998 to Wells et al. In this method a sample is pressed against the 0.1 mm circular face of a shaped IRE by a stage, a spectrum is collected, the sample is lowered, moved several micrometers, the sample raised and another spectrum is collected. This up-and-down process is very slow and extremely time consuming. The IRE is again aligned with the optical axis of the microscope and does not move.

The present invention is a new apparatus and method that is superior to the historical ATR methods because a much larger area of the sample can be interrogated, and at the same time, once the sample is mounted onto the crystal face, no other movement of the sample in relation to the IRE is required, thus, the sample is less prone to damage.

Also a magnification factor equal to the refractive index of the IRE is fully realized and the IRE size is only limited by the current ability to manufacture large refractive crystals. Using a 16-element linear array detector and obviating the need to raise and lower the sample to collect the spectrum makes the present invention much faster than the previous methods. Further, the present invention can image an area twice as large as the stationary drop down method in one-tenth the time.

Various objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

In accordance with the purposes of the present invention, as embodied and broadly described herein, the present invention includes an internal reflectance element assembly, that is defined by a crystal that has at least one measured dimension of about 5 mm or greater that is held in a holder structure shaped to hold the crystal, and a backer plate to secure a sample to the crystal.

The present invention further includes a corresponding method for performing attenuated total internal reflection microspectroscopic imaging with an apparatus, involving the steps of: placing the internal reflectance element assembly including a crystal of about 5 mm or greater on a microscope stage and centered with respect to the spatial point of maximum energy throughput, recording the spatial point of maximum energy in all three dimensional axes (x, y, and z), moving the internal reflectance element assembly in the x and y direction from about 2.4 mm or greater within the z-axis focal plane to acquire sample spectral data, acquiring background spectral data without including the sample within the internal reflectance element assembly, dividing the sample spectral data by said background spectral data to properly compensate at every data location resulting in compensated sample spectral data, and finally converting the compensated sample spectral data to absorbance units for post processing, data interpretation, or chemometric operations.

### BRIEF DESCRIPTION OF THE DRAWINGS

The accompanying drawings, which are incorporated in and form a part of the specification, illustrate the embodiments of the present invention and, together with the description, serve to explain the principles of the invention. In the drawings:

FIG. 1 shows the system setup of an ATR device utilizing one embodiment of the present invention.

FIG. 2 shows one embodiment of IRE assembly.

FIG. 3 is a flow chart detailing operational steps to measure a sample using the present invention.

FIG. 4 is a schematic showing how is the energy beam is bent by the IRE assembly crystal according to Snell's Law.

FIG. 5 shows a sample image of a human fingerprint that was imprinted onto the flat face of the IRE assembly crystal surface.

FIG. 6 graphically shows a background spectrum that was initially taken prior to acquiring data on the fingerprint in FIG. 5.

FIG. 7 graphically shows one fingerprint spectrum collected using the present invention apparatus and method.

FIG. 8 graphically shows the resultant spectra after converting the image to absorbance units and baseline corrected.

### DETAILED DESCRIPTION

The present invention is an apparatus and method for performing attenuated total internal reflection (ATR) microspectroscopic imaging using an internal reflectance element (IRE) of larger than typical radius that is coupled with a linear array detector.

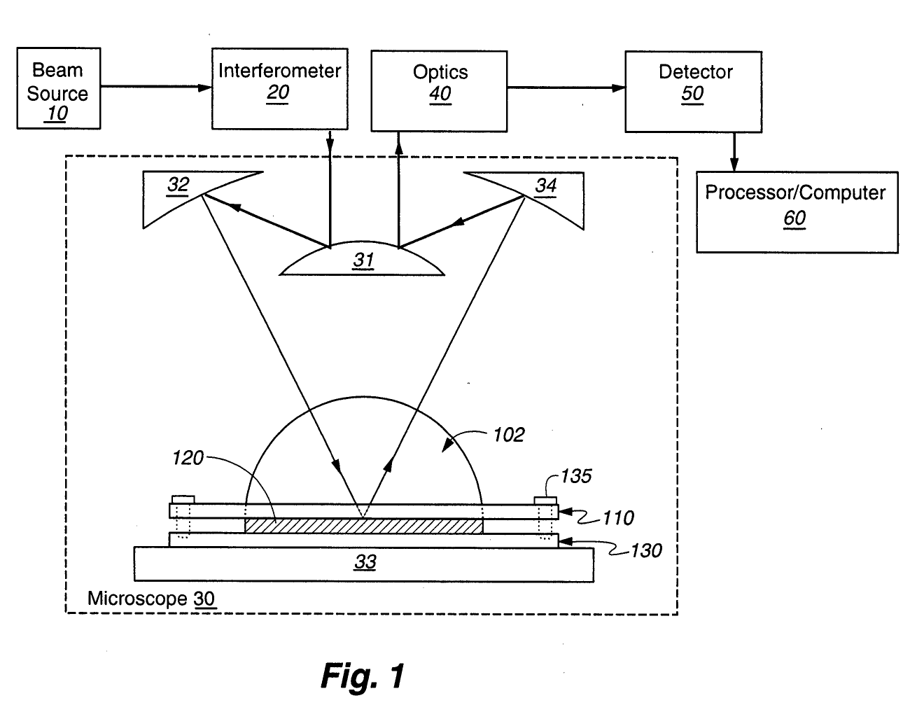

FIG. 1 shows the system setup of an ATR device utilizing one embodiment of the present invention. Beam source 10 provides the energy used to excite a response from a sample to be tested. Beam source 10 is an infrared energy source in a preferred embodiment; however, beam source 10 may be any energy source selected from the ultraviolet, visible, near infrared, and infrared energy regimes (wavelengths of 180×10⁻⁹ to 300×10⁻⁶ meters). Beam source 10 inputs a beam of energy into interferometer 20 that is a collimating optic device that provides a modulated intensity energy beam into microscope 30.

As the energy beam enters into microscope 30 it strikes first mirror 31 and is reflected into and off second mirror 32 down into IRE 100. After the energy beam enters IRE 100 is interacts with sample 120 and is reflected back through IRE 100 to third mirror 34 and on to first mirror 31 where it exits the microscope into optics package 40. Optics package 40 refocuses the energy beam onto detector 50.

Detector 50 receives the modulated energy beam signal and converts the intensity of the energy beam into electronic signals. The signals are then transmitted to processor 60 and recorded as a spectrum of wavelength versus intensity. Note that processor 60 may be a computer. The process of recording intensity versus wavelength is performed using software provided by the instrument manufacturer. Typical software packages include Spectrum™ by Perkin-Elmer and Wire™ by Renishaw.

In one embodiment, detector 50 is a 16-element mercury cadmium telluride (MCT) linear array detector that combines the speed of a multipixel detector, with the option of selecting the area to be interrogated from the visible image. The image is collected in a push broom mode. To collect an image, the sample is rastered under the energy beam, and the processor collects a 16 pixel high, user defined wide, image from the detector. The sample is then offset perpendicular to the raster motion, and another image 16 pixels high is collected. This process is repeated until the entire image, as defined by the operator, is collected. In another embodiment, a single pixel detector could be used; however, it would be 16 times slower. A focal plane array detector could also be used in this manner.

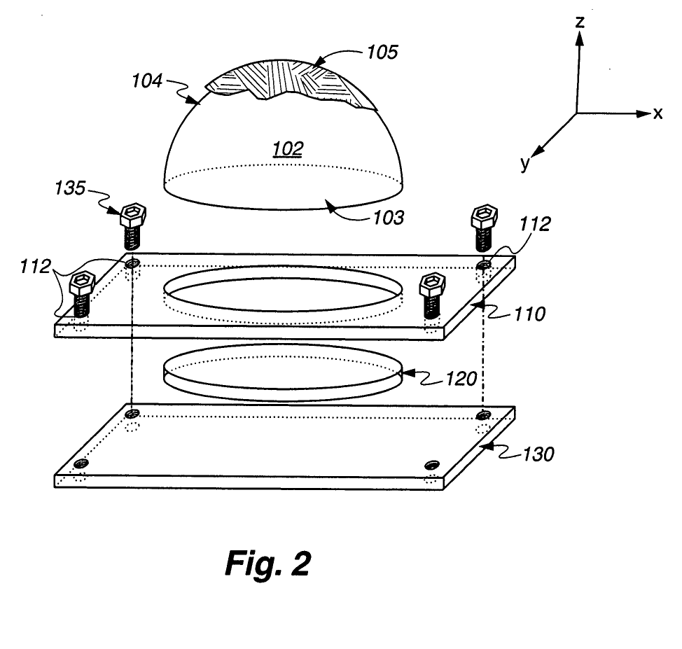

Referring now to FIG. 2, one embodiment of IRE assembly 100 includes holder structure 110 that is configured similar to a microscope slide with a hole in the center that is shaped to hold crystal 102. Structure 110 may include holes or slots 112 to accept guide or alignment pins 135. Structure 110 may be formed from any rigid structure, to include wood, plastic, or metal. Backer plate 130 is used to press sample 120 against flat face 103 of IRE 102. Physical contact between crystal 102 and sample 120 are desired as the evanescent field, created from light reflecting at the interface of the crystal and sample, extends only about 1-2 micrometers out of crystal 102. Backer plate 130 may also include alignment pins 135 that align backer plate 130 with structure 110 by fitting into holes or slots 112. Backer plate 130 may be formed from any rigid structure, to include wood, plastic, or metal.

In a preferred embodiment, crystal 102, is a solid hemisphere that is infrared transparent with a high refractive index with at least one measured dimension of about 5 mm to 152 mm. Crystals that exhibit these characteristics include but are not limited to: elemental germanium, silicon, diamond, as well as inorganic salts (e.g. zinc selenide, zinc sulfide). Note that crystal 102 may incorporate shapes other than a hemisphere, including Weierstrass (super hemisphere) as long as the shape serves to direct the infrared beam to sample 120. Crystal 102 may also be coated on upper surface 104 with antireflection coating 105. A large portion of the infrared energy is reflected at interfaces of high changes in refractive indices. Anti-reflection coatings assure a larger percentage of the energy passes through the crystal interface. Depending on the material used, crystal 102 size is only limited by the current ability to manufacture large refractive crystals; currently crystal exhibiting at least one measured dimension of about 5 mm to 152 mm may be procured from Spectral Systems, Inc.®.

Two separate measurements are required to perform ATR microspectroscopic imaging using an IRE. A spectral response of the instrument without the sample in place is taken, because the light path changes as the IRE/sample combination are rastered under the beam, each location must be properly compensated for, this measurement is called the background, and is always necessary in infrared spectral analysis. The background measurement may be made either before or after measuring the sample.

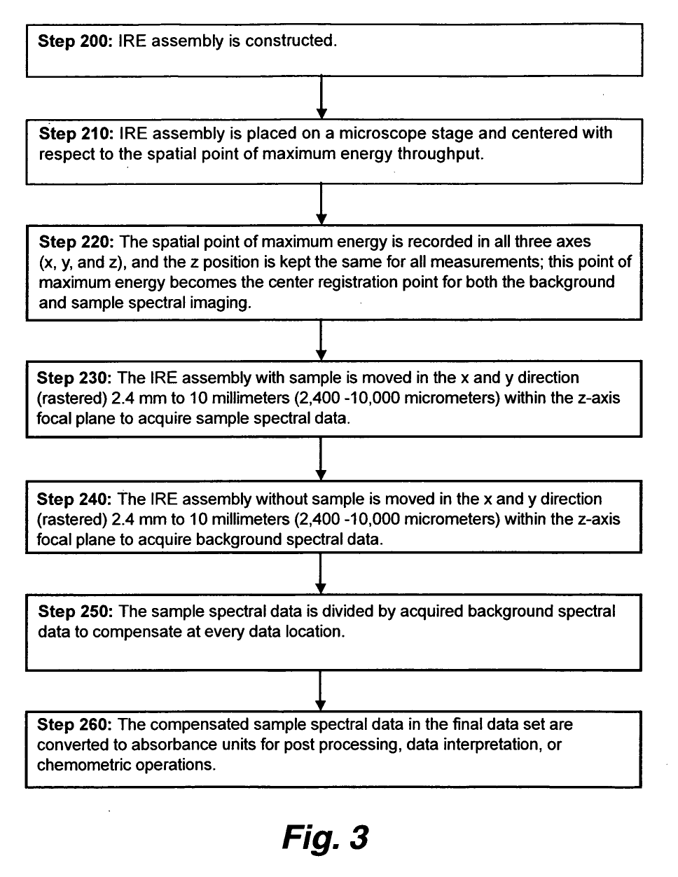

Referring now to FIG. 3, a flow chart detailing operational steps to measure a sample using the present invention, in Step 200, IRE assembly 100 is constructed by coupling IRE 102 into structure 110, and the placing sample 120 against flat face 103 and using backer plate 130 to press and hold sample 120 against IRE 102.

In Step 210, IRE assembly 100 is placed on microscope stage 33 and centered with respect to the spatial point of maximum energy throughput, which is found by moving IRE assembly 100 until detector 50 provides a maximum energy throughput to processor 60.

In Step 220, the spatial point of maximum energy is recorded in all three axes (x, y, and z), and the z position is kept the same for all measurements; this point of maximum energy becomes the center registration point for both the background and sample spectral imaging.

In Step 230, IRE assembly 100 is moved in the x and y direction (rastered) within the z-axis focal plane determined in Step 220. As a result, the interface of flat face 103 of crystal 102 and sample 120 interacts with the energy beam and an image is sequentially collected at detector 50 forming a 2-D image created by detecting energy absorption versus position in the respective x, y coordinate.

Prior art, using up to 3 mm diameter crystals, were limited to microscope stage movement (rastering) of 1.6×1.6 mm (1600 micrometers) or a useful distance of sample equal to about 0.4 mm (400 micrometers) before optical aberrations become too great. The stage movement is 4 times larger than the area of the sample observed because of the 4× magnification by the prior art hemisphere. However, the present invention using a crystal defining at least one measured dimension of 5 mm to 152 mm allows for stage movement (rastering) from 2.4 mm to 58.5 mm (2,400-58,500 micrometers) for a useful analysis area from 0.6×0.6 mm (600×600 micrometers) to 14.6×14.6 mm (14,600×14,600 micrometers). Thus, the present invention allows for up to a 30-fold increase in useful linear distance, and greater than a 1000-fold increase in actual sample analysis area, because optical aberrations decrease with increased crystal size.

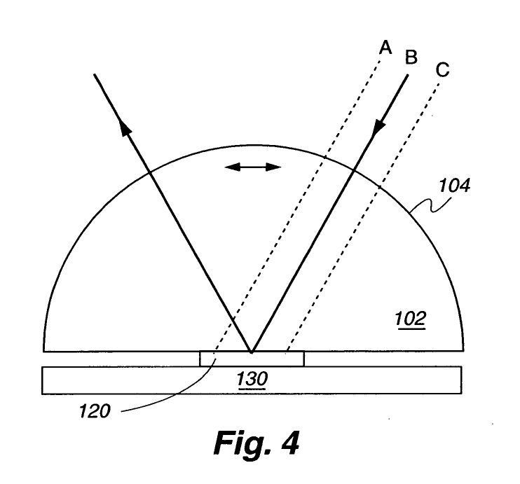

As shown in FIG. 4, as crystal 102 is moved off the energy beam path of maximum energy A-C, the energy beam is bent back towards energy beam B, according to Snell's Law. The amount of bending of the beam is governed by the change in angle between the energy beam and the upper surface 104 normal of crystal 102, as well as the refractive indices of both crystal 102 material and air. For example, if a small IRE is used and the IRE/sample is moved off axis, the angle changes significantly, however, if the IRE/sample is moved the same distance, but the IRE is larger in diameter than prior art, the angle of change will be proportionally much smaller. This effect diminishes with increasing IRE radius, meaning that the larger IRE of the present invention creates a less distorted image than what occurs when using a prior art smaller IRE.

In Step 240, step 230 is repeated but without sample 120 mounted within IRE assembly 100, the resulting data is the background spectral data.

In Step 250 the sample spectral data is divided by the background spectral data to compensate at every data location. This division produces the compensated sample spectral data in the final data set. Because each sample spectrum corresponds to a specific beam path in the crystal, a background must be collected of the same beam path to provide for proper environmental compensation. If the IRE is not properly placed, then the spectrum collected at the center of the sample will be divided by a spectrum in the background not at the center, baseline drift will occur and a loss of spectral accuracy will result. This may be done automatically by the software package provided with the instrument, but currently must be done with software provided by a third party vendor, such as Isys® by Spectral Dimensions, Inc. Those familiar with the art will recognize that this step is required in all spectral data collection.

Finally in Step 250, the compensated sample spectral data in the final data data set is converted to absorbance units for post processing and now, any data interpretation, or chemometric operations can be applied. These may include baseline corrections, principal component analysis, or others. Again, those familiar with the art will recognize that this step is required in all infrared data collection.

### EXAMPLE

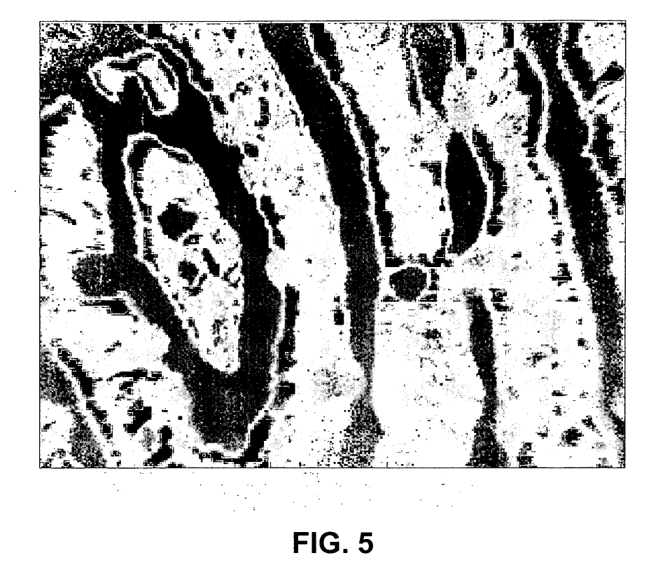

A sample image of a human fingerprint is presented in FIG. 5. The image corresponds to the total absorbance from 4000 to 650 cm⁻¹ (2.5 to 15 micrometer wavelength light). A finger was rubbed on the forehead to acquire a sufficient amount of human oils. The finger was then carefully placed onto the IRE to leave behind a print of the residual mixture.

The image was collected using a solid germanium hemispherical IRE (25 mm diameter) using a Perkin-Elmer Spotlight 300 infrared microscope. Because the instrument was not designed for this particular type of measurement a few of the steps had to be tailored for this instrument. Due to software limitations, the instrument cannot collect an image without a background. Therefore, a single point background was needed using a gold mirror. This single point background was used as the background for both the image without sample and the image with sample. Later, after data collection, when dividing the sample image by the background image, this single point background is completely removed from the data sets and is of no consequence. Second, since the fingerprint was an oily mixture placed directly onto the IRE, it was not necessary to use the backerplate to press it against the IRE.

The instrument, using a linear array detector 16×1, was able to collect the full image in approximately 40 minutes, with the same amount of time required for the background image. It is possible to collect a single beam image with the single point detector using this instrument, but the image collection time is very long. Each spectra was collected every 25 micrometers of stage travel, but due to the magnification factor of 4 by the germanium IRE, each spectrum of the sample is offset by approximately 6.25 micrometers. Therefore, to image 2 mm by 2.5 mm area, 130,000 discrete spectra were collected. Keep in mind that each spectrum contains not only the position information of an object, but also the chemical information. The image presented in FIG. 5 does not represent the limit of this process.

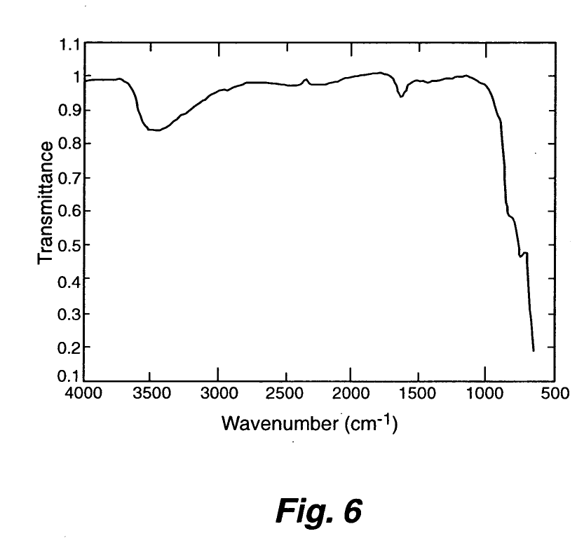

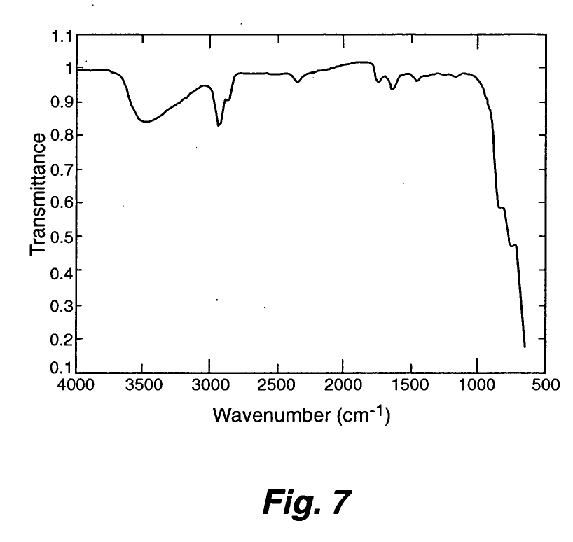

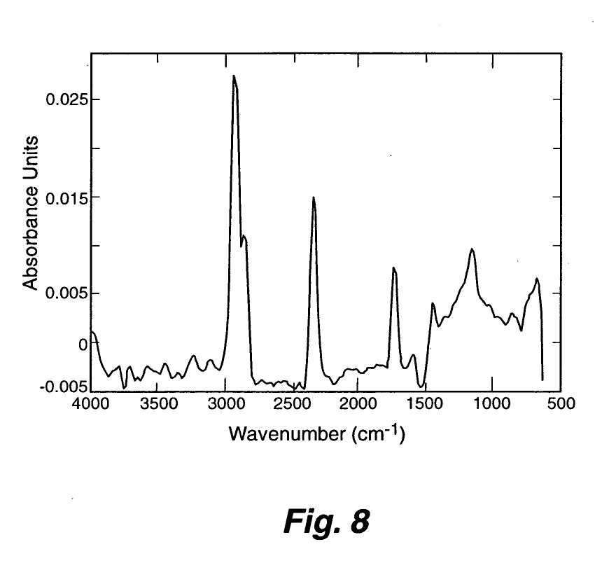

FIG. 6 shows the initial background spectrum. An image was then collected through the IRE assembly with the sample and the resultant spectrum are shown in FIG. 7, using the same original single point background. After collecting the background image and the sample spectra image, both datasets were imported into ISys®, a chemometric software package for post processing. Post processing included dividing the images to get the correct spectra response image, converting the image to absorbance units, as well as baseline correcting and the resultant is shown in FIG. 8.

The present invention is superior to the prior art of other ATR-IR imaging methods, for several reasons: first, once the sample is mounted onto the IRE face, no other movement of the sample in relation to the IRE is required, making it less likely to be damaged; second, a magnification factor equal to the refractive index of the IRE is realized; and third, by using a 16-element linear array detector the technique is extremely fast. Finally, through the use of an IRE larger than prior art use, the image size can be greatly increased. Thus, the present invention can image an area twice as large in one tenth the time of prior art methods

The foregoing description of the invention has been presented for purposes of illustration and description and is not intended to be exhaustive or to limit the invention to the precise form disclosed, and obviously many modifications and variations are possible in light of the above teaching.

The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. An internal reflectance element assembly for performing attenuated total internal reflection microspectroscopic imaging of a sample, comprising:
a. a crystal defined by at least one measured dimension of about 5 mm or greater,
b. a holder structure shaped to hold said crystal, and
c. a backer plate to secure said sample to said crystal.

2. The internal reflectance element assembly of claim 1, where said crystal is defined by at least one measured dimension of about 5 mm to 152 mm.

3. The internal reflectance element assembly of claim 1, where said crystal additionally comprises an antireflection coating to assure a larger percentage of energy passes through said crystal than would without said antireflection coating.

4. The internal reflectance element assembly of claim 1, where said backer plate further comprises alignment pins to align said backer plate with said holder structure.

5. An apparatus for performing attenuated total internal reflection microspectroscopic imaging of a sample, comprising:
a. an energy source that provides an energy beam,
b. an internal reflectance element assembly comprising a crystal defined by at least one measured dimension of about 5 mm or greater,
c. an interferometer that creates a modulated intensity energy beam from said energy beam,
d. a microscope used to focus said modulated intensity energy beam onto said internal reflectance element assembly,
e. an optics package to refocus said modulated intensity energy beam exiting said microscope,
f. a detector to receive said modulated intensity energy beam from said optics package and convert the intensity of said energy beam into electronic signals, and
g. a processor that records said electronic signals as spectra of wavelength versus intensity.

6. The apparatus of claim 5, where said crystal is defined by at least one measured dimension of about 5 mm to 152 mm.

7. The apparatus of claim 5, where said crystal additionally comprises an antireflection coating to assure a larger percentage of energy passes through said crystal than would without said antireflection coating.

8. The apparatus of claim 5, where said energy source is selected from the group consisting of ultraviolet, visible, near infrared, and infrared energy regimes.

9. The apparatus of claim 5, where said detector is selected from the group consisting of a 16-element linear array detector, a single pixel detector, and a focal plane array detector.

10. The apparatus of claim 5, where said processor is a computer.

11. A method for performing attenuated total internal reflection microspectroscopic imaging of a sample with an apparatus, comprising:
a. placing an internal reflectance element assembly including a crystal of about 5 mm or greater on a microscope stage and centered with respect to the spatial point of maximum energy throughput,
b. recording said spatial point of maximum energy in all three dimensional axes (x, y, and z),
c. moving said internal reflectance element assembly in the x and y direction from about 2.4 mm or greater within the z-axis focal plane to acquire sample spectral data,
d. acquiring background spectral data with said apparatus without including said sample in said internal reflectance element assembly,
e. dividing said sample spectral data by said background spectral data to compensate at every data location resulting in compensated sample spectral data, and
f. converting said compensated sample spectral data to absorbance units for post processing, data interpretation, or chemometric operations.

12. The method of claim 11 where said internal reflectance element assembly is constructed with said crystal defined by at least one measured dimension of about 5 mm to 152 mm.

13. The method of claim 11 where said internal reflectance element assembly is moved in the x and y direction from about 2.4 mm to 58.5 mm.
